(19) United States
(12) Patent Application Publication
(10) Pub. No.: US 2024/0011534 A1
(43) Pub. Date: Jan. 11, 2024

(54) BRAKE DISC HAVING STRUCTURAL FEATURES AT ITS CIRCUMFERENCE

(71) Applicant: HL MANDO CORPORATION, Pyeongtaek-si (KR)

(72) Inventors: Hatem SHAHIN, Pfaffenhofen (DE); Moritz RIEMER, Waldems (DE); Lothar WAGNER, Simmern (DE); Kai BRAUN, Friedrichsdorf (DE)

(73) Assignee: HL MANDO CORPORATION, Pyeongtaek-si (KR)

(21) Appl. No.: 18/218,767

(22) Filed: Jul. 6, 2023

(30) Foreign Application Priority Data
Jul. 6, 2022 (DE) 102022206926.9

(51) Int. Cl. F16D 65/12; F16D 65/00

(52) U.S. Cl. CPC F16D 65/12; F16D 65/0006; F16D 2065/1304

(57) ABSTRACT

The invention concerns a brake disc for a motor vehicle,
the brake disc having at least one first friction ring with:
   a first side surface having a friction surface;
   a second side surface opposite the first side surface; and
   a circumferential surface connecting the first side surface and second side surface;
wherein the circumferential surface comprises a plurality of structural features distributed in a circumferential direction, each structural feature comprising a projecting portion or a recessed portion.

### CROSS-REFERENCE TO RELATED APPLICATION

This application is based on and claims priority under 35 U.S.C. § 119 to German Patent Application No. 102022206926.9, filed on Jul. 6, 2022 in the German Patent and Trade Mark Office, the disclosures of which are incorporated herein by reference.

### TECHNICAL FIELD

The present invention relates to a brake disc and more particularly to a brake disc for a disc brake assembly of a vehicle, such as a car, a truck or a bus.

### BACKGROUND

A brake disc is generally used as a friction member of a disc brake assembly of a vehicle. A typical disc brake assembly includes a pair of brake pads disposed on either side of the brake disc and further includes means for pressing the brake pads against friction surfaces on either side of the brake disc. When the vehicle moves, the brake disc rotates jointly with the wheel on which the brake disc is mounted. To reduce the speed of the vehicle, the driver can apply the disc brake. As the disc brake is applied, the brake pads are pressed against the brake disc which creates friction between the stationary brake pads and the rotating brake disc and converts kinetic energy of the vehicle into heat and slowing down the vehicle.

However, in addition to generating heat, the friction between the brake pads and the brake disc can cause vibration and associated noise emissions from the brake disc.

DE 10 2019 204 407 A1 address this problem by adjusting dimensions and orientations of circumferential edges at friction rings of a brake disc. While this helps to reduce vibration and noise, there is still room for improvement.

### SUMMARY

The present invention is generally directed to providing a brake disc that is modified in a manner that reduces noise emissions caused by vibration of the brake disc. In addition, the invention is directed to avoiding, to the extent possible, those modifications that are costly or difficult to manufacture, and to avoiding, to the extent possible, those modifications that affect the mechanical stability or frictional properties of the brake disc.

The invention is defined in claim 1. Examples and preferred embodiments of the invention are disclosed in the dependent claims and in the following description, as well as in the drawings.

A brake disc according to the invention includes at least one first friction ring including a first side surface having a friction surface, a second side surface opposite the first side surface and a circumferential surface connecting the first and second side surface. The side surface has a plurality of structural features distributed along the circumference, each structural feature comprising a projection portion or a recessed portion, e.g. with respect to an adjacent region or a surrounding region of the circumferential surface.

By providing said structural features, a new design parameter is available to adjust vibration characteristics of the brake disc or, put differently, its dynamic behaviour. For example, a structure borne noises of the brake disc can be adjusted and reduced (e.g. squeal noises in a frequency range of e.g. 1 kHz to 12 kHz). This may be done so as to prevent or to reduce noises coming from a radial vibration of the brake disc. Additionally or alternatively, this may support decoupling of its in-plane-modes and/or limit its first (eigen) torsion mode which can cause so-called howl noises. It has been found that such improvements are achievable over a wide range of frequencies by providing the disclosed structural features.

Improvements regarding vibration and noise may be achieved for the brake disc as an individual component. Additionally or alternatively, such improvements may be achieved for a disc brake system comprising the brake disc, e.g. by limiting vibration coupling with other components, such as with the brake pads. Impacting the vibration characteristics of the brake disc may in particular include influencing and adjusting the Eigenfrequencies of the bake disc. This may be done so as to avoid interactions of vibration modes with the brake pads (in particular in case the brake pads vibrate in radial and tangential directions) and/or to limit in-plane-radial (IPR) and in-plan-circumferential (IPC) vibrations of the brake disc.

The disclosed structural features are advantageous in that they are simple to produce, do not require additional masses (or only very limited additional masses) and do not mechanically weaken the brake disc. There are also largely independent of a material choice or of specific design choices of the brake disc. For example, they are applicable to ventilated or non-ventilated brake discs and/or to brake discs having a single friction ring or multiple friction rings. They are also compatible to other vibration and/or noise countermeasures, such as brake pad shims, brake pad chamfers or brake pad slots. Moreover, is has been found that their impact on the vibration characteristics is not highly sensitive to manufacturing tolerances. Further, the disclosed structural features can maintain their desired impact on the vibrational characteristics regardless of wear or disc damages (e.g. cracks or minor fractures).

The first and second side surface may extend in parallel to one another. They may be substantially smooth. They may extend orthogonally to a rotation axis about which the brake disc and its friction rings are configured to rotate. Said rotation axis may coincide with the rotation axis of the wheel to be braked by a disc brake assembly comprising the brake disc.

Terms such as axial, radial and circumferential used herein may relate to said rotation axis. An axial direction may extend along the rotation axis, a radial direction may extend at an angle and in particular orthogonally to said rotation axis and a circumferential direction may extend around or about said rotation axis.

Apart from the structural features, the circumferential surface may be smooth and/or may have a constant diameter. It may have an axial width or a thickness of not more than 5 cm. Said width or thickness may be smaller than a diameter of the friction ring, e.g. may comprise less than 5% or less than 1% of said diameter of the friction ring.

According to an embodiment, all structural features comprised by the circumferential surface comprise projecting portions or all structural features comprised by the circumferential surface comprise recessed portions. Put differently, the type of structural feature may be uniform.

Additionally or alternatively, the projecting portion may have a rounded shape and in particular may have a half-spherical shape, a half-ellipsoid shape, a dome shape or an outwardly bulging shaped.

In one aspect, the projection portion has a rounded cross-section at its base, in particular a circular cross-section. The base may coincide with and/or merge with and/or directly be adjacent to the circumferential surface. The rounded shaped may generally be free of any corners and/or angles (of e.g. less than 120°). This helps to prevent stress concentrations that may result from a remaining level of vibrations.

Any of the projecting portion and recessed portion may overlap with an axial center of the friction ring and/or of its circumferential surface. Any of the projecting portion and recessed portion may extend across the complete axial width of the friction ring and/or of its circumferential surface or across at least half said width. This overlap and extension may help to achieve the effects of the structural features in a particular reliable manner.

In one example, the recessed portion comprises one of a slot, a groove and a cut-out. These may be elongated. They may extend axially, e.g. with their longitudinal axis being oriented in parallel to the rotation axis. They may be free of sharp edges, angles or corners, in particular at their base which coincides with and/or merges with and/or may directly be adjacent to the circumferential surface. This again helps to limit stress concentrations.

According to one embodiment, the structural features are non-uniformly sized. For example, they may be of the same type (and e.g. only one type being provided overall), but at least two different sizes thereof may be provided.

The type of the structural feature referred to herein may generally concern its configuration as either a projecting portion or a recessed portion, i.e. said projecting portion and recessed portion are the different types of structural features.

Varying the sizes of the structural features provides an additional design parameter by means of which the dynamic behaviour of the brake disc can be adjusted. In particular, it may be used to include a non-symmetrical or a non-regular arrangement of the structural features along the circumferential surface, e.g. by the sizes of the structural features varying irregularly in the circumferential direction. This may help to clearly set at least one Eigenfrequency of the brake disc apart from further components of a brake disc system that are coupled or coupable to the brake disc. Additionally or alternatively, the vibration characteristics may thus be adjusted to limit orthogonal modes of the brake disc.

Generally, the structural features may be non-regularly distributed in the circumferential direction. This may in particular include similarly sized structural features and/or only one type of structural features being provided. The non-regular distribution may include a non-regular angular spacing and/or circumferential distance between adjacent structural features. Again, this may be a particularly effective means to differentiate at least one

Eigenfrequency of the brake disc from other components of a brake disc system. In particular, the vibration characteristics may thus be adjusted to limit orthogonal modes of the brake disc itself.

The brake disc optionally comprises and second friction ring wherein the brake disc further has a second friction ring that also has:
a first side surface having a friction surface;
a second side surface opposite the first side surface; and
a circumferential surface connecting the first side surface and second side surface of said second friction ring;
   wherein the second side surfaces of the first friction ring and the second friction ring face each other.

A plurality of ribs may be disposed between the first friction ring and a second friction ring. These may connect the second side surfaces of the first friction ring and the second friction ring and form cooling channels (sometimes referred to as ventilation channels) in between.

The first friction ring and second friction ring may have an identical diameter and/or an identical axial width. Alternatively, differences between their diameter and/or an axial width may not exceed 20%.

The circumferential surface of the second friction ring may be free of structural features comprising any of a projecting portion or a recessed portion. Put differently, it may be smooth and/or closed and/or comprise only one radial level (e.g. one diameter). This may limit complexity and manufacturing costs of the brake disc.

Alternatively, the circumferential surface of the second friction ring may comprise a plurality of structural features distributed in a circumferential direction, each structural feature comprising a projecting portion or a recessed portion. In other words, according to this alternative the circumferential surface may generally be structured similarly to the first friction ring (e.g. by comprising similar types of structural features). Nonetheless, as discussed herein, there may still be differences between the structures of the circumferential surfaces of the first friction ring and the second friction ring.

In more detail, according to one example, the structural features of the first friction ring and of the second friction ring are shaped and/or are circumferentially positioned identically to one another. This may provide a particular regular and effective adjustment of the dynamic behaviour of the complete brake disc.

Alternatively, the structural features of the first friction ring and of the second friction ring may differ from one another at least with respect to one of the following:
their circumferential positions, e.g. the circumferential position of at least one structural feature (or of at least a quarter or all structural features) of the first friction ring not coinciding with the circumferential position of at least one structural feature (or of at least a quarter or all structural features) of the second friction ring;
the respectively comprised type of the projecting portion or recessed portion, e.g. the first friction ring comprising (in particular only) one of said types and the second friction ring comprising (in particular only) the respective other one of said types;
their size, e.g. at least one or at least a quarter or all structural features the first friction ring having a different size compared to the structural features of the second friction ring, wherein in particular all of the structural features of said first friction ring and of the second friction ring may be of the same type;
their distribution in a circumferential direction. e.g. the structural features of one of the first friction ring and second friction ring being regularly distributed, whereas the structural features of the respective other of the first friction ring and second friction ring being non-regularly distributed.

By introducing any of the above differences between the first friction ring and the second friction ring, a dynamical decoupling may be introduced between the friction rings. Additionally or alternatively, the dynamic behaviour and in particular the Eigenfreuquncies of a brake disc comprising a respective combination of first and second friction ring may be set clearly apart from other components of a brake disc system comprising the brake disc.

### BRIEF DESCRIPTION OF DRAWINGS

Embodiments of the invention are discussed below with reference to the attached schematic figures. Same or similar features may be marked with same reference signs throughout the figures.

FIG. 1 is a cross-sectional view of a brake disc according to a first embodiment;

FIG. 2 is a detail view of the brake disc of FIG. 1;

FIG. 3 is a cross-sectional view of a brake disc according to a second embodiment;

FIG. 4 is a detail view of the brake disc of FIG. 3;

FIG. 5 is a cross-sectional view of a brake disc according to a third embodiment;

FIG. 6 is a detail view of the brake disc of FIG. 5;

FIG. 7 is a cross-sectional view of a brake disc according to a fourth embodiment;

FIG. 8 is a detail view of the brake disc of FIG. 7;

FIG. 9 is an exemplary front view of a brake disc for illustrating possible circumferential distributions of structural features according to further embodiments of the invention.

### DETAILED DESCRIPTION

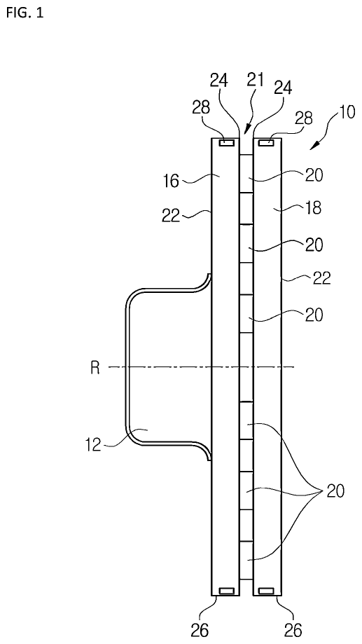

FIG. 1 is a cross-sectional view of a brake disc 10 according to a first embodiment. The brake disc 10 is configured to rotate about a rotation axis R. It is concentrically arranged with respect to said rotational axis R. The cross sectional plane of FIG. 1 comprises said rotation axis R, so that FIG. 1 represents a cross-sectional side view of the brake disc 10.

The brake disc 10 comprises a hub portion 12 for being mechanically coupled to a non-illustrated vehicle wheel and/or to a non-illustrated rotating axle component. The brake disc 10 also comprises two friction rings, a first friction ring 16 and a second friction ring 18. The friction rings 16, 18 are both circular and arranged concentrically with respect to the rotation axis R. They are similarly sized in terms of their diameter and axial width. They are connected to one another and are axially spaced apart from one another by means of optional ribs 20. Free spaces in between said ribs 20 form ventilation channels.

Each friction ring 16, 18 comprises a first side surface 22 forming a friction surface for being contacted by a non-illustrated brake pad. The first side face 22 of each friction ring 16, 18 faces away from the ribs 20 and/or the respective other friction ring 16, 18.

Each friction ring 16, 18 also comprises a second side surface 24 which is opposite to and faces away from a respective first side surface 22. Each second side surface 24 face the respective other friction ring 16, 18, i.e. the second side surfaces 24 generally face one another. The ribs 20 connect said second side surfaces 24. The second side surfaces 24 may also be referred to as ventilation surfaces.

Each friction ring 16, 18 further has a circumferential surface 26 that connects the first and second side surface 20, 24 of the respective friction rings 16, 18. Each circumferential surface 26 is arranged concentrically with respect to the rotation axis R and extends about or around said rotational axis R. Each circumferential surface 26 faces radially outwardly.

In known brake discs, said circumferential surface is typically smooth and/or closed. In particular, it has one radial level and/or one diameter formed by its outer surface, said radial level and/or diameter being constant and non-varying in a circumferential direction.

In the depicted embodiment, to the contrary, the radial level and/or diameter of the circumferential surface 26 varies, in particular when viewed along a circumferential direction. This is the result of structural features 21 in form of recessed portions 28 being provided in each circumferential surface 26.

In the shown example, the recessed portions 28 of the friction rings 16, 18 are similarly sized and are regularly distributed along the circumferential surface 26. They form radial recesses having a radial dimension of e.g. less than 5 cm and in particular between 0.5 and 2 cm. Their axial width is smaller than that of the friction rings 16, 18 (e.g. at least 10% smaller) which improves rigidity. The extension in the circumferential direction is limited to e.g. less than 10 cm and in particular less than 5 cm, which again prevents an extensive mechanical weakening of the friction rings 16, 18. The spacing between circumferentially adjacent recessed portions 28 in each friction ring 16, 18 is regular and e.g. amounts to between 5° and 20′.

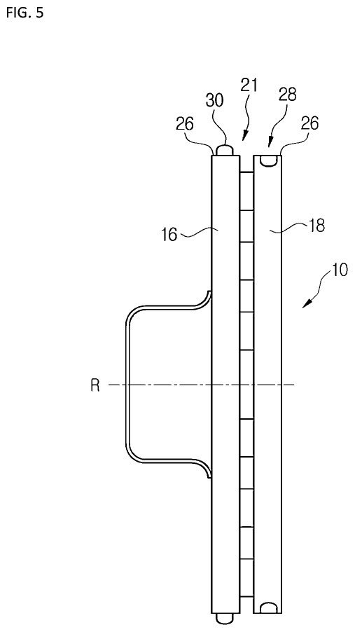

Other non-regular distributions or non-identical configurations and/or non-identical positions between the structural features 21 of the frictional ring 16, 18 can be provided as well, see e.g. the discussion of FIGS. 5-8 below.

Also, it is noted that the presence of the ribs 20 and/or of a second friction ring 18 is not mandatory. For example, there may be only one friction ring 16 having friction surfaces at both of its side surfaces 22, 24.

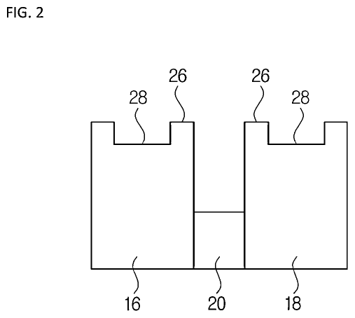

FIG. 2 is a detail view showing an upper portion of the brake disc of FIG. 1 and specifically the recessed portions 28 provided thereat. The recessed portions 28 are elongated grooves extending in a circumferential direction, whereas in FIG. 2 only a cross-section thereof is visible.

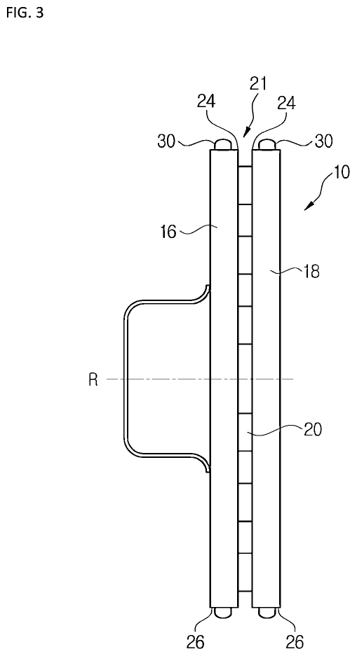

FIG. 3 is a cross-sectional view of a brake disc 10 according to a second embodiment. The basic design of this brake disc 10 is similar to that of FIG. 1, e.g. with respect to two friction rings 16, 18 having similar first and second surfaces 22, 24, the latter being connected by ribs 20. A difference to FIG. 1 is the type of structural feature 21 provided at the circumferential surfaces 26 of the friction rings 16, 18. Specifically, projecting portions 30 are provided. Again, these may be identically sized and identically arranged at both of the friction rings 16, 18. Also, the circumferential dimension of each projecting portion 30 may again be limited to e.g. less than 5 cm. A radial height of each projecting portion may be less than 5 cm and in particular less than 3 cm.

Generally, any dimensions of the structural features at the circumferential surfaces 26 disclosed in connection with the embodiments may also be provided independently of the further details of said embodiments. In other words, they represent general aspects of this disclosure that are not limited to the exact embodiments depicted in the figures. Also, the disclosed dimensions haven been found to achieve significant improvements in terms of adjusting the dynamic behaviour, while e.g. limiting an additional mass and/or mechanical weakening of the brake disc.

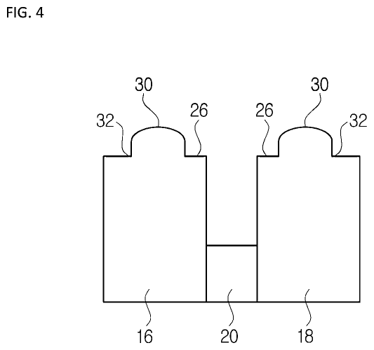

FIG. 4 is a detail view of an upper portion of the brake disc of FIG. 3. The projecting portions 30 each have rounded and in particular circular bases 32 that merge with the circumferential surfaces 26. Accordingly, the projecting portions 30 may be formed as cylindrical projecting portions with circular bases 32 and may in particular be half-spheres.

FIG. 5 is a cross-sectional view of a brake disc 10 according to a third embodiment. The difference compared to the first and second embodiment again concerns the type of structural features 21 that are provided at the circumferential surfaces 26 of the first and second friction rings 16, 18. In the third embodiment, the type of structural features 21 varies between the first and second friction rings 16, 18. Therefore, the first friction ring 16 and the second friction ring 18 are non-identically configured.

Instead, at the circumferential surface 26 of the first friction ring 16, projecting portions 30 similar to those of FIG. 3 are provided. At the second friction ring 18, however, recessed portions 28 are provided. Generally, said recessed portions 28 may be configured according to any of the examples disclosed herein, in particular as a slot similar to the first embodiment of FIGS. 1 and 2. In the depicted third embodiment, however, this recessed portion 28 is (as a mere example) formed as a half-spherical or as a dome-shaped indentation, although the depicted shapes may also correspond to cross-section of a groove extending in the circumferential direction.

Again, the structural features 21 provided at the circumferential surfaces 26 of the first friction ring 16 and of the second friction ring 18 may be similarly positioned and distributed in a circumferential direction, even though the type of structural feature 21 differs from one another.

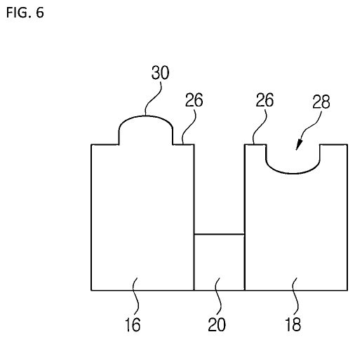

FIG. 6 is a detail view of the brake disc of FIG. 5 and more clearly illustrates the exemplary shapes and extensions of the projecting portions 30 and recessed portions 28.

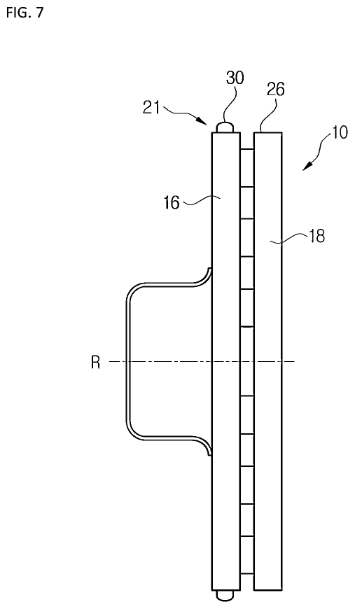

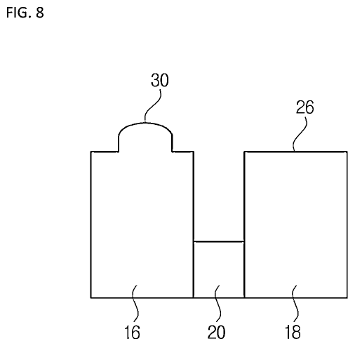

FIG. 7 is a cross-sectional view of a brake disc 10 according to a fourth embodiment and FIG. 8 is a detail view of said brake disc 10. In this case, only one of the friction rings 16, 18 (the left one in FIGS. 5 and 6) comprises a structural feature 21 in form of a projecting portion 30. Said projecting portion 30 may be configured according to FIG. 3 and specifically according to any variant discussed in connection with the example of FIG. 3.

The circumferential face 26 of the other friction ring (the right friction ring 18 in FIGS. 7 and 8), to the contrary, is free of any structural features 21. Rather, it is smooth and closed and has a constant diameter along its circumference.

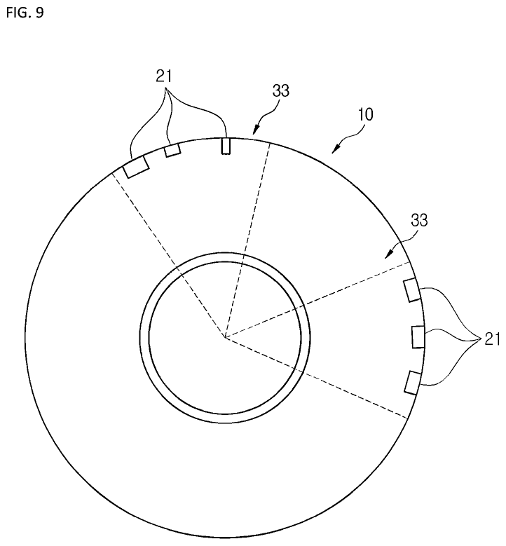

FIG. 9 highly schematically illustrates embodiments for distributing the structural features 21 in any and preferably both friction rings 16, 18 in a circumferential direction. Generally, the depicted brake disc 10 and the schematically indicated structural features 21 may be configured according to any of the disclosed embodiments.

FIG. 9 shows two different angular segments 33 of the brake disc 10 each including a number of structural features 21. Only one type of the depicted angular segments 33 may actually be present and said single type may cover the complete angular space, i.e. said segment may include 360°.

A first (in FIG. 9 upper) segment 33 illustrates that differently sized structural features 21 may be provided and that these may be non-uniformly circumferentially spaced. A second (in FIG. 9 right) segment 33 illustrates an alternative configuration according to which the structural features 21 may be identically sized and uniformly circumferentially spaced.

Of course, it is also possible to provide differently sized, yet uniformly circumferentially spaced structural features 21 or uniformly sized, yet non-uniformly circumferentially spaced structural features 21.

What is claimed is:

1. A Brake disc for a motor vehicle,
the brake disc having at least one first friction ring with:
a first side surface having a friction surface;
a second side surface opposite the first side surface; and
a circumferential surface connecting the first side surface and second side surface;
wherein the circumferential surface comprises a plurality of structural features distributed in a circumferential direction, each structural feature comprising a projecting portion or a recessed portion.

2. The brake disc according to claim 1,
wherein all structural features comprised by the circumferential surface comprise projecting portions or all structural features comprised by the circumferential surface comprise recessed portions.

3. The brake disc according to claim 1,
wherein the projecting portion has a rounded shape and in particular has a half-spherical shape, a half-ellipsoid shape, a dome shape or an outwardly bulging shaped.

4. The brake disc according to claim 1,
wherein the projection portion has a rounded cross-section at its base, in particular a circular cross-section.

5. The brake disc according to claim 1,
wherein the recessed portion comprises one of a slot, a groove and a cut-out.

6. The brake disc according to claim 1,
wherein the structural features are non-uniformly sized.

7. The brake disc according to claim 1,
wherein the structural features are non-regularly distributed along the circumferential surface.

8. The brake disc according to claim 1,
wherein the brake disc further has a second friction ring that also has:
a first side surface having a friction surface;
a second side surface opposite the first side surface; and
a circumferential surface connecting the first side surface and second side surface of said second friction ring;
wherein the second side surfaces of the first friction ring and the second friction ring face each other, wherein the circumferential surface of the second friction ring also comprises a plurality of structural features distributed in a circumferential direction, each structural feature comprising a projecting portion or a recessed portion.

9. The brake disc according to claim 8,
wherein the structural features of the first friction ring and of the second friction ring are shaped and/or circumferentially positioned identically to one another.

10. The brake disc according to claim 8,
wherein the structural features of the first friction ring and of the second friction ring differ from one another at least with respect to one of the following:
their circumferential positions;
the respectively comprised structural of either the projecting portion or the recessed portion;
their size
their distribution in a circumferential direction.
